(19) United States
(12) Patent Application Publication
(10) Pub. No.: US 2024/0291828 A1
(43) Pub. Date: Aug. 29, 2024

(54) SEARCHING DEVICE, SEARCH RANGE DETERMINATION METHOD, AND SEARCH RANGE DETERMINATION PROGRAM

(71) Applicant: NIPPON TELEGRAPH AND TELEPHONE CORPORATION, Tokyo (JP)

(72) Inventors: Kazuma SHINOMIYA, Tokyo (JP); Kazunori KAMIYA, Tokyo (JP)

(73) Assignee: NIPPON TELEGRAPH AND TELEPHONE CORPORATION, Tokyo (JP)

(21) Appl. No.: 18/570,561

(22) PCT Filed: Jun. 17, 2021
(86) PCT No.: PCT/JP2021/023065

§ 371 Date: Dec. 14, 2023

(51) Int. Cl. H04L 9/40

(52) U.S. Cl. CPC H04L 63/1408; H04L 63/164

(57) ABSTRACT

A passive acquisition data analysis unit (11) analyzes data observed in a communication network. An active acquisition data analysis unit (12) analyzes data obtained by searching the communication network. A data output unit (14) outputs data for specifying an IP address to be searched for based on an analysis result from the passive acquisition data analysis unit (11) and an analysis result from the active acquisition data analysis unit (12).

### TECHNICAL FIELD

The present invention relates to a search device, a search range determination method, and a search range determination program.

### BACKGROUND ART

Conventionally, there are known techniques for searching for IP addresses in an IPV4 space in order to discover malicious IP addresses.

For example, a technique is known in which a search is performed by narrowing down IP addresses advertised by border gateway protocol (BGP) (see, for example, NPL 1 and 2).

In addition, for example, in searching for a malicious website, a technique is known in which a malignancy score of each URL is predicted by machine learning on the basis of WHOIS information, an associated FQDN, the numerical value of each octet of the IP address, etc., and the URLs are rearranged in order of the malignancy score (see, for example, NPL 3).

Also, for example, there is known a technique for estimating a malicious IP address by machine learning using network flow information (see, for example, NPL 4).

### CITATION LIST

### Non Patent Literature

[NPL 1] Antonio Nappa, et al., “CyberProbe: Towards Internet-Scale Active Detection of Malicious Servers,” NDSS, 2014.
[NPL 2] Zhaoyan Xu, et al., “AUTOPROBE: Towards Automatic Active Malicious Server Probing Using Dynamic Binary Analysis,” ACM CCS, 2014
[NPL 3] Daiki Chiba, Tatsuya Mori, and Shigeki Goto, “Deciding priority crawling in searching for malicious websites,” CSS, 2012.
[NPL 4] Bo Hu; Kazunori Kamiya; Kenji Takahashi; Akihiro Nakao, Piper: A Unified Machine Learning Pipeline for Internet-scale Traffic Analysis

### SUMMARY OF INVENTION

### Technical Problem

However, the conventional techniques have a problem in that they may not be able to efficiently search for IP addresses.

For example, in the techniques described in NPL 1 and 2, there are about 2.6 billion candidates after narrowing down about 4.3 billion IP addresses in the IPV4 space, and the narrowing down is not sufficient.

In addition, for example, since C&C servers and malicious file distribution servers in botnets often do not have domain names, and WHOIS and FQDN cannot be acquired in many cases, there are cases where the technique of NPL 3 cannot be applied. Further, due to the huge number of IP addresses (for example, about 4.3 billion), ordering by machine learning is very computationally expensive.

Also, for example, in the technique of the NPL 4, since only passively acquired data is used, it is not clear whether or not an IP address estimated to be malicious is actually malicious.

### Solution to Problem

In order to solve the above-mentioned problems and achieve the object, there is provided a search device including: a passive acquisition data analysis unit that analyzes data observed in a communication network; an active acquisition data analysis unit that analyzes data obtained by searching the communication network; and a data output unit that outputs data for specifying an IP address to be searched for based on an analysis result from the passive acquisition data analysis unit and an analysis result from the active acquisition data analysis unit.

### Advantageous Effects of Invention

According to the present invention, it is possible to efficiently search for an IP address.

### BRIEF DESCRIPTION OF DRAWINGS

FIG. 1 is a diagram illustrating an example of a configuration of a search device according to a first embodiment.

FIG. 2 is a diagram illustrating an example of a configuration of a search range determination program.

FIG. 3 is a diagram illustrating an example of a configuration of a passive acquisition data analysis unit.

FIG. 4 is a diagram illustrating an example of a configuration of an active acquisition data analysis unit.

FIG. 5 is a diagram illustrating an example of a configuration of a data integration unit.

FIG. 6 is a diagram illustrating an example of a configuration of a data output unit.

FIG. 7 is a flowchart illustrating a flow of processing of the search device according to the first embodiment.

FIG. 8 is a diagram illustrating an example of a computer that executes the search range determination program.

### DESCRIPTION OF EMBODIMENTS

Hereinafter, embodiments of a search device, a search range determination method, and a search range determination program according to the present application will be described in detail with reference to the drawings. Note that, the present invention is not limited to the embodiments to be described below.

### Configuration of First Embodiment

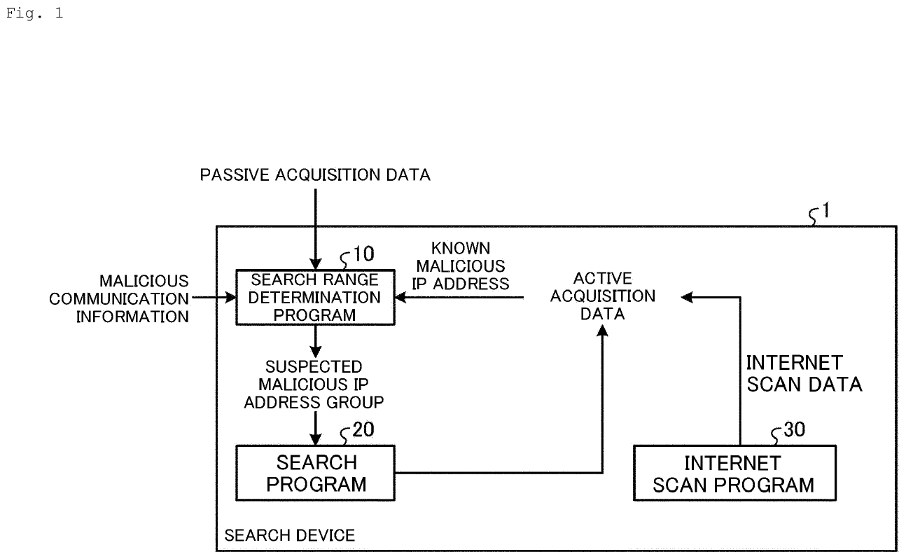

First, a configuration of a search device according to a first embodiment will be described with reference to FIG. 1. FIG. 1 is a diagram illustrating an example of a configuration of the search device according to the first embodiment.

The search device 1 specifies a suspected malicious IP address group on the basis of various types of data, and searches for IP addresses included in the suspected malicious IP address group to discover malicious IP addresses.

As illustrated in FIG. 1, the search device 1 includes a search range determination program 10, a search program 20, and an Internet scan program 30. The search range determination program, the search program, and the Internet scan program may also be referred to as a search range determination unit, a search unit, and an Internet scan unit, respectively.

The search range determination program 10 outputs a suspected malicious IP address group on the basis of passive acquisition data, active acquisition data, and malicious communication information. The active acquisition data includes a known malicious IP address, Internet scan data, and the like.

The search program 20 searches for IP addresses included in the suspected malicious IP address group. The Internet scan program 30 scans the entire Internet to obtain Internet scan data.

The details of each program and data described with reference to FIG. 1 will be described.

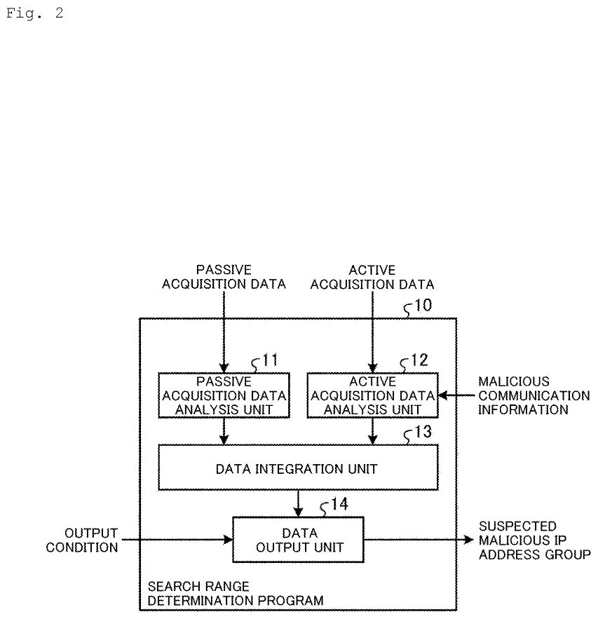

FIG. 2 is a diagram illustrating an example of a configuration of the search range determination program. As illustrated in FIG. 2, the search range determination program 10 includes a passive acquisition data analysis unit 11, an active acquisition data analysis unit 12, a data integration unit 13, and a data output unit 14.

The passive acquisition data analysis unit 11 analyzes data observed in a communication network. For example, the passive acquisition data analysis unit 11 analyzes network flow data, BGP data, whois data, and passive DNS data.

The active acquisition data analysis unit 12 analyzes data obtained by searching a communication network. For example, the active acquisition data is data acquired by actively accessing an arbitrary host such as an output result of a search program and an Internet scan result. Also, searching a communication network corresponds to, for example, actively researching or searching for an IP address.

The search range determination program 10 finally outputs suspected IP address groups whose numbers and properties correspond to output conditions through processing by the data integration unit 13 and the data output unit 14. By searching for these suspected IP address groups, a malicious host in a large-scale network can be searched for and discovered more efficiently than before.

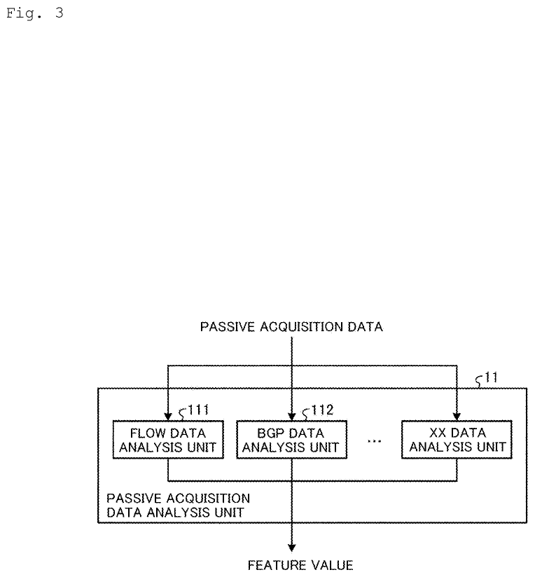

FIG. 3 is a diagram illustrating an example of a configuration of the passive acquisition data analysis unit. The passive acquisition data analysis unit 11 analyzes the passive acquisition data and extracts a feature value.

For example, the passive acquisition data analysis unit 11 extracts the malignancy score and various feature values based on the result of analyzing the network flow data, the advertisement IP, AS number, and allocation range based on the result of analyzing the BGP data, the allocation organization based on the result of analyzing the whois data, and the like as feature values.

As illustrated in FIG. 3, the passive acquisition data analysis unit 11 includes analysis units that analyze passive acquisition data for each type. A flow data analysis unit 111 analyzes network flow data. A BGP data analysis unit 112 analyzes BGP data.

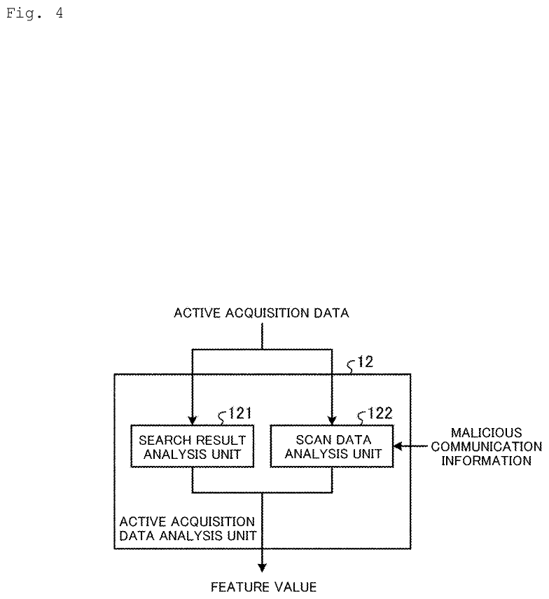

FIG. 4 is a diagram illustrating an example of a configuration of the active acquisition data analysis unit. The active acquisition data analysis unit 12 analyzes the active acquisition data and extracts a feature value.

The active acquisition data analysis unit 12 analyzes data including a search result indicating whether an IP address is malicious or not. The active acquisition data analysis unit 12 includes a search result analysis unit 121 and a scan data analysis unit 122.

For example, the search result analysis unit 121 analyzes at least one of a determination result from a program for determining a malicious IP address, a determination date and time, and information on related malware.

Specifically, the search result analysis unit 121 analyzes an output result of the search program 20 that actually searches a suspected malicious IP address range and outputs an IP address that is truly malignant, and outputs a malignancy determination result, a malignancy determination time, malware information identifying what kind of malware the server sends commands to, and the like.

The scan data analysis unit 122 can analyze the Internet scan data output by the Internet scan program 30 and output results of estimating malicious IP addresses and malware information.

For example, the scan data analysis unit 122 obtains information indicating the degree of malignancy for each IP address on the basis of information indicating the tendency of malicious communication information and communication information for each IP address obtained by scanning the Internet.

In this case, no malicious IP address information is given to the Internet scan data. On the other hand, the malicious communication information included in the active acquisition data includes information such as an IP address and a payload.

Therefore, the scan data analysis unit 122 can obtain a malicious IP address by collating the Internet scan data with the active acquisition data.

For example, the scan data analysis unit 122 determines that the communication destination IP address and the port number are malicious if the communication content of the Internet scan data matches or is similar to the payload of the malicious communication information included in the active acquisition data.

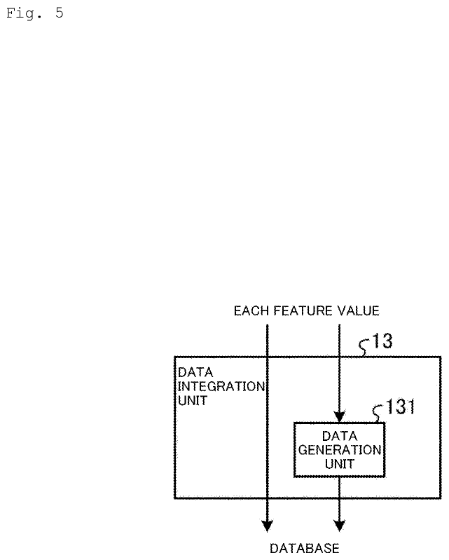

FIG. 5 is a diagram illustrating an example of a configuration of the data integration unit. The data integration unit 13 further analyzes each feature value extracted by the passive acquisition data analysis unit 11 and the active acquisition data analysis unit 12, and stores information for each IP address in a database.

As illustrated in FIG. 5, the data integration unit 13 may generate new information by using each feature value through a data generation unit 131.

For example, the data generation unit 131 generates an AS item to which each IP address belongs or an item indicating whether the IP belongs to an organization by using the malicious IP address information extracted by the active acquisition data analysis unit 12 and the BGP information extracted by the passive acquisition data analysis unit 11.

Also, for example, the data generation unit 131 generates the degree of malignancy based on the number of hops by using the malicious IP address information extracted by the active acquisition data analysis unit 12 and the network flow information extracted by the passive acquisition data analysis unit 11.

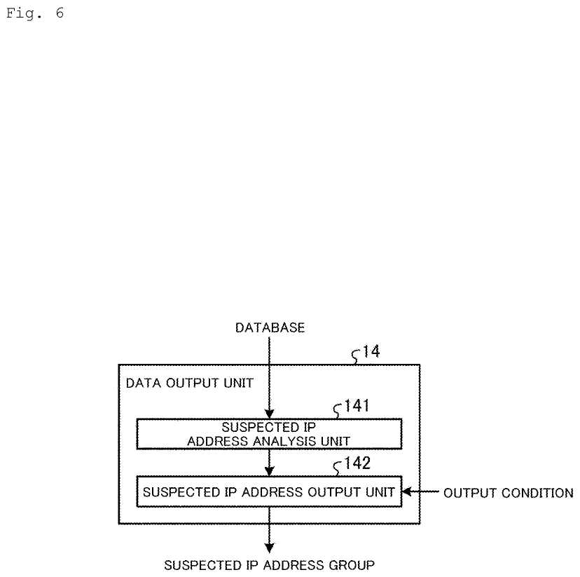

FIG. 6 is a diagram illustrating an example of a configuration of the data output unit. The data output unit 14 outputs data for specifying an IP address to be searched for on the basis of an analysis result from the passive acquisition data analysis unit 11 and an analysis result from the active acquisition data analysis unit 12.

The data output unit 14 includes a suspected IP address analysis unit 141 and a suspected IP address output unit 142.

The suspected IP address analysis unit 141 ranks IP addresses in descending order of the degree of malignancy by scoring or machine learning on the basis of the information of the IP addresses in the database stored by the data integration unit 13.

On the basis of output conditions (the number, properties, etc. of IP addresses), the suspected IP address output unit 142 outputs an IP address group that matches the conditions as a suspected IP address group.

Also, the suspected IP address output unit 142 outputs the suspected IP address group according to ranking by the suspected IP address analysis unit 141. The suspected IP address group output here is an example of data for specifying an IP address to be searched for.

### (Feedback of Search Result)

The data output unit 14 may receive a search result from the search program 20 as feedback, and output a suspected IP address group on the basis of the received feedback.

At this time, the data output unit 14 outputs data for specifying an IP address having a feature similar to the feature of the malicious IP address obtained on the basis of the search result. The search result from the search program 20 is included in the active acquisition data.

For example, the data output unit 14 performs scoring or modeling so that the IP addresses determined to be malicious by the search program 20 are ranked higher.

### Processing in First Embodiment

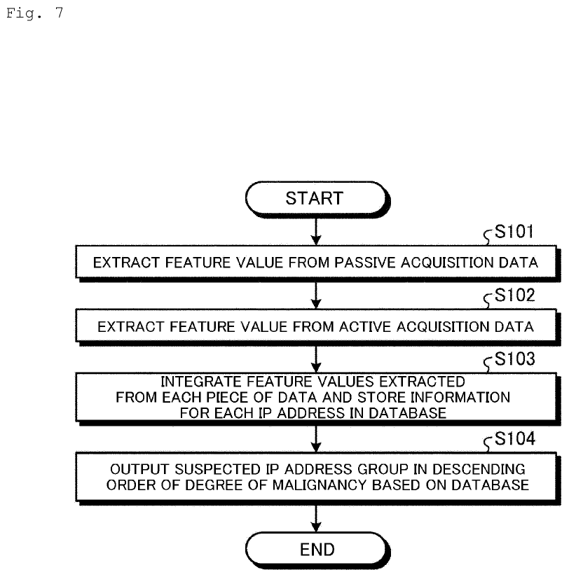

The flow of processing by the search range determination program 10 of the search device 1 will be described with reference to FIG. 7. FIG. 7 is a flowchart illustrating a flow of processing of the search device according to the first embodiment.

First, the search device 1 extracts a feature value from the passive acquisition data (step S101). The search device 1 also extracts a feature value from the active acquisition data (step S102).

Next, the search device 1 integrates the feature values extracted from each piece of data and stores information for each IP address in a database (step S103). Then, the search device 1 outputs the suspected IP address group in descending order of the degree of malignancy based on the database (step S104).

### Effects of First Embodiment

As described so far, the passive acquisition data analysis unit 11 analyzes data observed in the communication network. The active acquisition data analysis unit 12 analyzes data obtained by searching the communication network. The data output unit 14 outputs data for specifying an IP address to be searched for on the basis of an analysis result from the passive acquisition data analysis unit 11 and an analysis result from the active acquisition data analysis unit 12.

Thus, in the present embodiment, not only passive acquisition data but also active acquisition data acquired by scanning or probing are used to narrow down the IP address to be searched for, so that it is possible to efficiently search for an IP address.

The active acquisition data analysis unit 12 analyzes data including a search result indicating whether an IP address is malicious or not. The data output unit 14 outputs data for specifying an IP address having a feature similar to the feature of the malicious IP address obtained on the basis of the search result.

From only the passive acquisition data, it is not possible to obtain whether an IP address is searched for as a malicious one or not. Therefore, by feeding back the search result as in the present embodiment, it is possible to improve the accuracy of narrowing down.

The active acquisition data analysis unit 12 obtains information indicating the degree of malignancy for each IP address on the basis of information indicating the tendency of malicious communication information and communication information for each IP address obtained by scanning the Internet.

In this way, by combining the communication information with the scan data, it is possible to obtain information which could not be obtained from individual data.

The active acquisition data analysis unit 12 analyzes at least one of a determination result from a program for determining a malicious IP address, a determination date and time, and information on related malware.

In this way, by combining passive acquisition data and active acquisition data obtained from different information, it is possible to improve the accuracy of narrowing down.

### System Configuration, Etc

Further, each component of each illustrated device is a functional conceptual component and does not necessarily need to be physically configured as illustrated in the drawings. That is, a specific form of distribution and integration of the respective devices is not limited to the form illustrated in the drawings, and all or some of the devices can be distributed or integrated functionally or physically in any units according to various loads, and use situations. Further, all or some of processing functions to be performed in each device can be realized by a central processing unit (CPU) and a program analyzed and executed by the CPU, or can be realized as hardware using a wired logic. The program may be executed not only by the CPU but also by another processor such as a GPU.

Further, among processing operations described in the present embodiment, all or some of processing operations described as being automatically performed can be manually performed, or all or some of processing operations described as being manually performed can be automatically performed by a known method. In addition, the processing procedure, the control procedure, specific names, information including various types of data and parameters that are shown in the above document and drawings may be arbitrarily changed unless otherwise described.

### Program

As one embodiment, the search device 1 can be implemented by installing a search range determination program which executes the above search processing as package software or online software on a desired computer. For example, an information processing device can be constituted to function as the search device 1 by causing the information processing device to execute the above search range determination program. The information processing device mentioned herein includes a desktop or laptop personal computer. In addition, information processing devices include smartphones, mobile communication terminals such as mobile phones and personal handyphone systems (PHSs), and slate terminals such as personal digital assistants (PDAs).

The search device 1 can also be implemented as a search server device that uses a terminal device used by a user as a client and provides the client with services related to the above search processing. For example, the search server device is implemented as a server device that provides a search service that receives passive acquisition data and active acquisition data and outputs a suspected malicious IP address group. In this case, the search server device may be implemented as a Web server, or may be implemented as a cloud that provides services related to the above search processing through outsourcing.

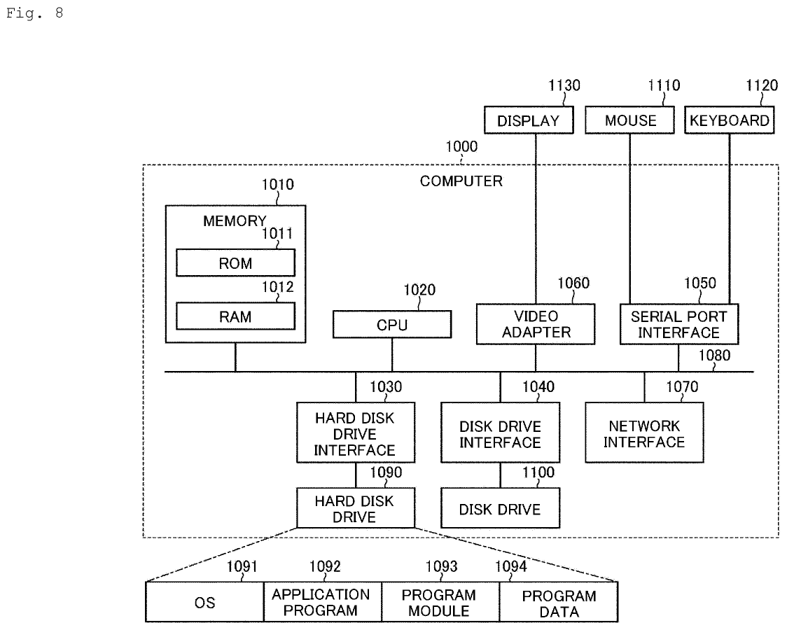

FIG. 8 is a diagram illustrating an example of a computer that executes the search range determination program. A computer 1000 includes, for example, a memory 1010 and a CPU 1020. Further, the computer 1000 also includes a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a random access memory (RAM) 1012. The ROM 1011 stores, for example, a boot program, such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, the program that defines each process of the search device 1 is implemented as the program module 1093 in which a code that can be executed by the computer is described. The program module 1093 is stored in, for example, the hard disk drive 1090. For example, the program module 1093 for executing the same processing as the functional configuration in the search device 1 is stored in the hard disk drive 1090. Note that the hard disk drive 1090 may be replaced with a solid state drive (SSD).

Furthermore, the setting data used in the processing of the above-described embodiment is stored, for example, in the memory 1010 or the hard disk drive 1090 as the program data 1094. The CPU 1020 reads the program module 1093 or the program data 1094 stored in the memory 1010 or the hard disk drive 1090 into the RAM 1012 as necessary, and executes the processing of the above-described embodiment.

Note that the program module 1093 and the program data 1094 are not limited to being stored in the hard disk drive 1090, and may be stored in, for example, a detachable storage medium and read by the CPU 1020 via the disk drive 1100 or the like. Alternatively, the program module 1093 and the program data 1094 may be stored in another computer connected via a network (local area network (LAN), a wide area network (WAN), and the like). Then, the program module 1093 and the program data 1094 may be read by the CPU 1020 from another computer via the network interface 1070.

### REFERENCE SIGNS LIST

1 Search device
10 Search range determination program
11 Passive acquisition data analysis unit
12 Active acquisition data analysis unit
13 Data integration unit
14 Data output unit
20 Search program
30 Internet scan program
111 Flow data analysis unit
112 BGP data analysis unit
121 Search result analysis unit
122 Scan data analysis unit
131 Data generation unit
141 Suspected IP address analysis unit
142 Suspected IP address output unit

1. A search device comprising a processor configured to execute operations comprising:
generating a passive data analysis result of analyzing data observed in a communication network;
generating an active data analysis result of analyzing data obtained by searching the communication network; and
determining a network address to be searched based on the passive data analysis result and the active data analysis result;
transmitting the network address to an application configured to search the network address to generate a set of suspected network addresses.

2. The search device according to claim 1,
wherein the generating an active data analysis result further comprises analyzing data including a search result indicating whether the network address is malicious or not, and
the determining the network address further comprise outputting data for specifying the network address having a feature similar to a feature of a malicious network address obtained based on the search result.

3. The search device according to claim 1, wherein the generating an active data analysis result further comprises obtaining information indicating a degree of malignancy for each network address based on information indicating a tendency of malicious communication information and communication information for each network address obtained by scanning the Internet.

4. The search device according to claim 1, wherein the generating an active data analysis result further comprises analyzing at least one of a determination result from a program instruction for determining a malicious network address, a determination date and time, or information on related malware.

5. A computer-implemented method for determining a search range, comprising:
generating a passive data analysis result of analyzing data observed in a communication network;
generating an active data analysis result of analyzing data obtained by searching the communication network; and
determining a network address to be searched based on the passive data analysis result and the active data analysis result;
transmitting the network address to an application configured to search the network address to generate a set of suspected network addresses.

6. A computer-readable non-transitory recording medium storing a computer-executable program instructions that when executed by a processor a computer system to execute operations comprising:
generating a passive data analysis result of analyzing data observed in a communication network;
generating an active data analysis result of analyzing data obtained by searching the communication network; and
determining a network address to be searched based on the passive data analysis result and the active data analysis result;
transmitting the network address to an application configured to search the network address to generate a set of suspected network addresses.

7. The search device according to claim 2, wherein the generating an active data analysis result further comprises obtaining information indicating a degree of malignancy for each network address based on information indicating a tendency of malicious communication information and communication information for each network address obtained by scanning the Internet.

8. The search device according to claim 2, wherein the generating an active data analysis result further comprises analyzing at least one of a determination result from a program instruction for determining a malicious network address, a determination date and time, or information on related malware.

9. The search device according to claim 3, wherein the generating an active data analysis result further comprises analyzing at least one of a determination result from a program instruction for determining a malicious network address, a determination date and time, or information on related malware.

10. The computer-implemented method according to claim 5,
wherein the generating an active data analysis result further comprises analyzing data including a search result indicating whether the network address is malicious or not, and
the determining the network address further comprise outputting data for specifying the network address having a feature similar to a feature of a malicious network address obtained based on the search result.

11. The computer-implemented method according to claim 5, wherein the generating an active data analysis result further comprises obtaining information indicating a degree of malignancy for each network address based on information indicating a tendency of malicious communication information and communication information for each network address obtained by scanning the Internet.

12. The computer-implemented method according to claim 5, wherein the generating an active data analysis result further comprises analyzing at least one of a determination result from a program instruction for determining a malicious network address, a determination date and time, or information on related malware.

13. The computer-implemented method according to claim 10, wherein the generating an active data analysis result further comprises obtaining information indicating a degree of malignancy for each network address based on information indicating a tendency of malicious communication information and communication information for each network address obtained by scanning the Internet.

14. The computer-implemented method according to claim 10, wherein the generating an active data analysis result further comprises analyzing at least one of a determination result from a program instruction for determining a malicious network address, a determination date and time, or information on related malware.

15. The computer-implemented method according to claim 11, wherein the generating an active data analysis result further comprises analyzing at least one of a determination result from a program instruction for determining a malicious network address, a determination date and time, or information on related malware.

16. The computer-readable non-transitory recording medium according to claim 6,
wherein the generating an active data analysis result further comprises analyzing data including a search result indicating whether a network address is malicious or not, and
the determining the network address further comprise outputting data for specifying the network address having a feature similar to a feature of a malicious network address obtained based on the search result.

17. The computer-readable non-transitory recording medium according to claim 6, wherein the generating an active data analysis result further comprises obtaining information indicating a degree of malignancy for each network address based on information indicating a tendency of malicious communication information and communication information for each network address obtained by scanning the Internet.

18. The computer-readable non-transitory recording medium according to claim 6, wherein the generating an active data analysis result further comprises analyzing at least one of a determination result from a program instruction for determining a malicious network address, a determination date and time, or information on related malware.

19. The computer-readable non-transitory recording medium according to claim 16, wherein the generating an active data analysis result further comprises obtaining information indicating a degree of malignancy for each network address based on information indicating a tendency of malicious communication information and communication information for each network address obtained by scanning the Internet.

20. The computer-readable non-transitory recording medium according to claim 16, wherein the generating an active data analysis result further comprises analyzing at least one of a determination result from a program instruction for determining a malicious network address, a determination date and time, or information on related malware.
